(19) United States
(12) Patent Application Publication
(10) Pub. No.: US 2006/0026158 A1
(43) Pub. Date: Feb. 2, 2006

(54) Sorting method utilizing memory space efficiently, machine-readable medium thereof, and related apparatus

(76) Inventor: Chia-Jung Hsu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/160,920

(22) Filed: Jul. 15, 2005

Related U.S. Application Data
(60) Provisional application No. 60/521,984, filed on Jul. 30, 2004.

(30) Foreign Application Priority Data
Dec. 16, 2004 (TW) 093139230

(51) Int. Cl. G06F 7/00; G06F 12/00

(52) U.S. Cl. 707/7; 711/158

(57) ABSTRACT

The present invention discloses a sorting method using a memory as an auxiliary tool to sort a plurality of items stored in a storage device. The method includes the following steps: (a) retrieving full information of an item to be sorted from the storage device; (b) comparing only partial information of the item to be sorted with partial information of at least one already sorted item stored in the memory to determine an order of the item to be sorted and the already sorted items; and (c) storing partial information of the already sorted items and partial information of the item to be sorted into the memory according to the determined order.

### CROSS REFERENCE TO RELATED APPLICATIONS

This application claims the benefit of U.S. Provisional Application No. 60/521,984, which was filed on Jul. 30, 2004 and entitled “Cost Effective Approach for Sorting Information on Storage Device”.

### BACKGROUND

The present invention relates to data sorting, and more particularly, to a sorting method utilizing memory space efficiently.

“Sorting” is a task frequently performed by modern electronic systems. A plurality of items (each of the items can be a piece of data) is arranged in a specific order, such as an alphabetical order, through sorting. Generally speaking, an objective of sorting is to let human beings seek data more conveniently, since it is easier for human beings to search already sorted items than search unsorted items.

A processor always sorts a plurality of items stored in a storage device (such as a nonvolatile storage device) by utilizing a memory, such as a volatile memory, as an auxiliary tool. For the processor, accessing the memory is usually faster than accessing the storage device. In the related art, there is a simple way of sorting. The processor first moves all information need to be sorted from the storage device into the memory. Then, the processor sorts the information stored in the memory directly, without further accessing the storage device. For example, assume that a plurality of file names is going to be sorted into alphabetical order. The processor first moves the entire file name of each of the files into the memory, then starts sorting the file names stored in the memory. Since time required for accessing the storage device is saved, the sorting time is reduced. However, the above-mentioned sorting manner consumes a lot of memory space. When great amount of information is contained in each item to be sorted, unnecessary memory space consumption become a serious problem.

In addition, in the related art, before the sorting process is completely finished, the temporary sorting result could be saved as a file. On the other hand, after the sorting process is completely finished, the final sorting result also may be saved as a file into the storage device. However, the processor must access the sorting result through the storage device, rather than through the memory. This increases time required for further analyzing the sorting result. Also, in the related art, the temporary/final sorting result may be stayed in memory for the next time resorting, but it will be memory consuming.

In ordinary personal computers, since there is plenty of available memory space, the above-mentioned space-consuming sorting manner is acceptable. However, there are more and more electronic devices, such as cellular phones, proposed with limited memory space. It is therefore required to provide a new sorting method utilizing memory space more efficiently.

### SUMMARY

An objective of the claimed invention is to provide a sorting method utilizing memory space more efficiently.

According to the claimed invention, a sorting method for sorting a plurality of items stored in a storage device by utilizing a memory is disclosed. The method includes: (a) retrieving full information of an item to be sorted from the storage device; (b) comparing only partial information of the item to be sorted with partial information of at least one already sorted item stored in the memory to determine an order of the item to be sorted and the already sorted items; and (c) storing partial information of the already sorted items and partial information of the item to be sorted into the memory according to the determined order.

Besides, the method of the claimed invention can also be recorded in any kind of storage media in a form of a program code. When the program code is loaded and executed by a machine, the machine becomes an apparatus implementing ideas of the claimed invention.

Instead of full information of already sorted item(s), in the sorting process of the claimed invention only partial information of already sorted item(s) is stored in the memory. Hence, not much memory space is required. In other words, the memory space is utilized more efficiently. Apparently, the ideas of the claimed invention can be appropriately applied in electronic devices having limited memory space.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of a sorting apparatus according to an exemplary embodiment of the present invention.

FIG. 2 shows a flowchart illustrating the method of the present invention.

FIG. 3 shows an example of a plurality of items stored in the storage device waiting to be sorted.

FIG. 4 shows tables illustrating how information stored in the memory changes in the sorting process of the example.

### DETAILED DESCRIPTION

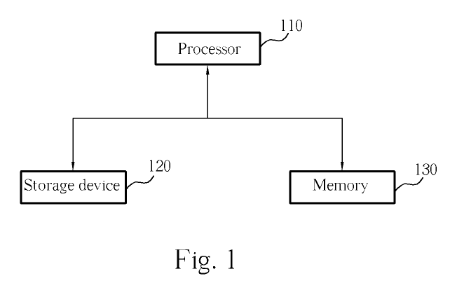

Please refer to FIG. 1. FIG. 1 shows a block diagram of a sorting apparatus according to an exemplary embodiment of the present invention. The sorting apparatus of this embodiment includes a processor 110, a storage device 120, and a memory 130. The apparatus can be set in a cellular phone. The storage device 120 of this embodiment is a nonvolatile storage device, such as a hard disc or a flash memory. The storage device 120 stores a plurality of items waiting to be sorted; each of the items can represent a file, a folder, or a character string. The memory 130 of this embodiment is a volatile memory, such as a random access memory (RAM). The memory 130 is used by the processor 110 as an auxiliary tool when the processor 110 sorts the items stored in the storage device 120. More particularly, in this embodiment the memory 130 provides space to the processor 110 for storing a search pointer, full information of an item to be sorted, a partial information list, and an address list. In the partial information list, partial information of at least one already sorted item is recorded according to the order determined by the processor 110. In the address list, addresses of the already sorted items in the storage device 120 are stored according to the order determined by the processor 110.

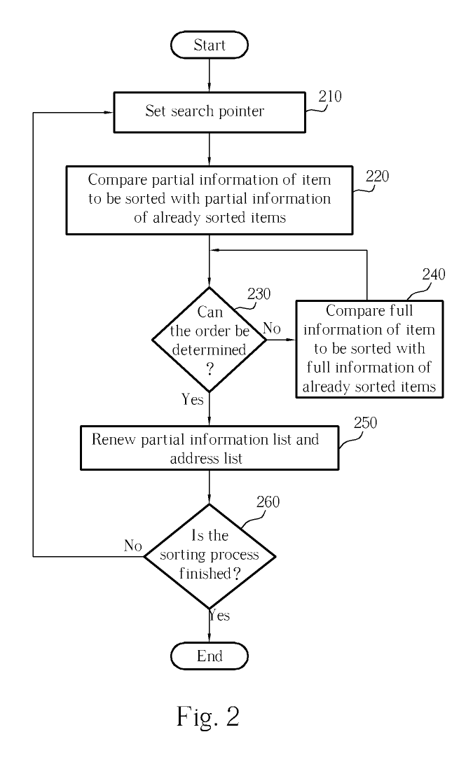

FIG. 2 is an exemplary flowchart illustrating a method performed by the processor 110 of FIG. 1 according to the present invention. The steps of FIG. 2 are as follows:

Step 210: Set the search pointer according to an address of an item to be sorted in the storage device 120.

Step 220: Retrieve full information of the item to be sorted according to the search pointer. Compare only partial information of the item to be sorted with partial information of the already sorted items recorded in the partial information list to determine an order of the item to be sorted and the already sorted items.

Step 230: 1f the order of the item to be sorted and the already sorted items can be determined, go to step 250; otherwise, go to step 240.

Step 240: Retrieve full information of at least one item having the same partial information as the item to be sorted among the already sorted items from the storage device 120. Compare full information of the item to be sorted with full information of the item(s) having the same partial information as the item to be sorted to determine the order of the item to be sorted and the already sorted items.

Step 250: Renew the partial information list and the address list according to the order of the item to be sorted and the already sorted items determined in step 220 or step 240.

Step 260: If all items stored in the storage device 120 are already sorted, end this flowchart; otherwise, go back to step 210.

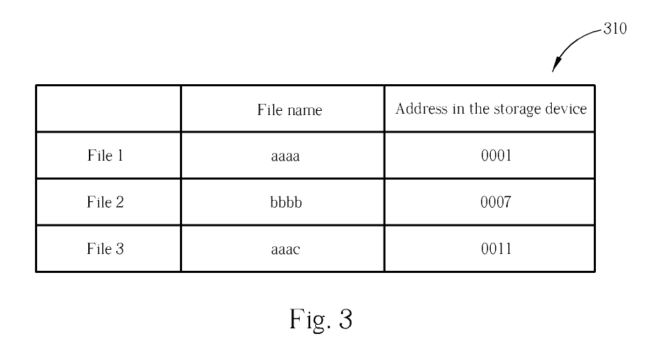

The following paragraphs provide an example illustrating how the method of the present invention is performed. Assume that originally there are three items stored in the storage device 120 waiting to be sorted. Each item represents a file. That is, each item is the filename of the represented file. Table 310 of FIG. 3 shows file names (i.e. the three items) and the addresses of the filenames stored in the storage device 120. The three items are going to be arranged according to an alphabetical order of the file names. Partial information of an item refers to first two characters of the file name, and full information of the item refers to all the characters of the file name. Please note that system designers can also determine the definition of partial information and full information.

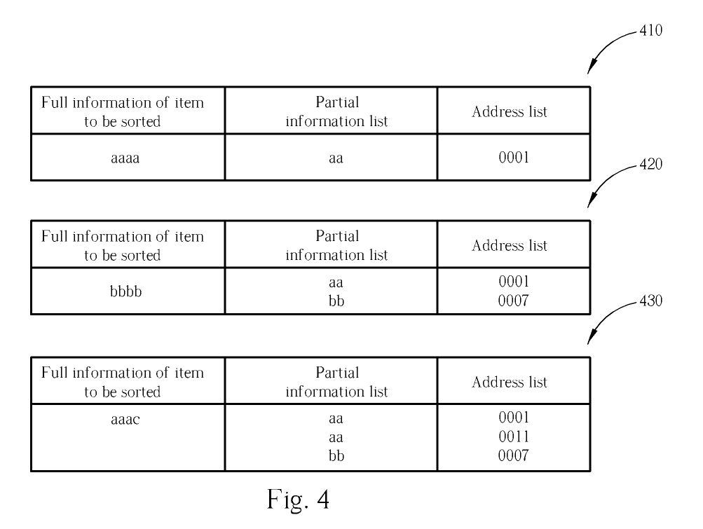

When step 210 is performed for the first time, the processor 110 sets the search pointer according to an address of a first item to be sorted (i.e. Filename 1) in the storage device 120. Next, in step 220, the processor 110 retrieves full information of Filename 1, which is “aaaa”, according to the search pointer. Since there is no already sorted item at this moment, no comparison is required. The processor 110 directly goes to step 230 and then step 250. In step 250, the processor stores partial information of Filename 1 into the partial information list, and stores the address of Filename 1 in the storage device 120 into the address list. After passing step 250 for the first time, information stored in the memory 130 is as illustrated by table 410 of FIG. 4.

Since there are still two more items in the storage device 120 that need to be sorted, after passing step 260, the processor 110 goes back to step 210. In step 210, the processor 110 sets the search pointer according to an address of a second item to be sorted (i.e. Filename 2) in the storage device 120. In step 220, the processor 110 retrieves full information of Filename 2, which is “bbbb”, according to the search pointer. The processor 110 then compares partial information of Filename 2 (which is “bb”) with partial information of already sorted item (which is “aa”) stored in the partial information list. Since the order of these two files can be determined through comparing partial information “aa” and “bb”, the processor 110 passes step 230 and then go to step 250. In step 250, the partial information list and the address list stored in the memory 130 are renewed according to the order determined by the processor 110. In the renewed partial information list, partial information “bb” of Filename 2 is stored in a column next/following to the column storing partial information “aa” of Filename 1. In the renewed address list, the address “0007” of Filename 2 in the storage device 120 is stored in a column next/following to the column storing the address “0001” of Filename 1 in the storage device 120. After passing step 250 for the second time, information stored in the memory 130 is as illustrated by table 420 of FIG. 4.

Since there is still one more item in the storage device 120 that needs to be sorted, after passing step 260, the processor 110 goes back to step 210. In step 210, the processor 110 sets the search pointer according to an address of a third item to be sorted (i.e. Filename 3) in the storage device 120. In step 220, the processor 110 retrieves full information of Filename 3, which is “aaac”, according to the search pointer. The processor 110 then compares partial information of Filename 3 (which is “aa”) with partial information of already sorted items (“aa” and “bb”) stored in the partial information list. The order of Filename 2 and Filename 3 can be determined through comparing partial information “aa” and “bb”. However, the processor 110 cannot determine the order of Filename 1 and Filename 3 through comparing partial information “aa” and “aa” of these two filenames. Hence, the processor 110 passes step 230 and then goes to step 240. In step 240, the processor 110 retrieves full information of Filename 1 from the storage device 120 according to the address list (since the address list includes a column storing the address “0001” of Filename 1 in the storage device 120). Then, the processor 110 compares retrieved full information of Filename 1 (which is “aaaa”) with full information of Filename 3 (which is “aaac”) to determine the order of these two filenames. Consequently, the order of Filename 1, Filename 2, and Filename 3 can be determined now. The processor 110 passes step 230 and then goes to step 250. In step 250, the partial information list and the address list stored in the memory 130 are renewed according to the order determined by the processor 110. In the renewed partial information list, partial information “aa” of Filename 3 is stored in a column next/following to the column storing partial information “aa” of Filename 1 and before another column storing partial information “bb” of Filename 2. In the renewed address list, the address “0011” of Filename 3 in the storage device 120 is stored in a column next/following to the column storing the address “0001” of Filename 1 in the storage device 120 and before another column storing the address “0007” of Filename 2 in the storage device 120. After passing step 250 for the third time, information stored in the memory 130 is as illustrated by table 430 of FIG. 4. Since there are no further items needing to be sorted, the processor 110 then passes step 260 and ends the flowchart of FIG. 2.

After the above-mentioned sorting process is finished, memory space for storing the search pointer, full information of the last sorted item, and the partial information list in the memory 130 can be released. The processor 110 can access the sorted items according to the address list stored in the memory 130 in sequence, and display the sorting result according to accessed information. If the sorting result is not required further, the memory space for storing the address list in the memory 130 could then be released.

Instead of full information of already sorted item(s), in the sorting process of the present invention only partial information of already sorted item(s) is stored in the memory 130. Hence, not much memory space is required. Only when an item to be sorted has the same partial information as an already sorted item does the processor 110 retrieve full information of the already sorted item to compare with full information of the item to be sorted. Then the order of the item to be sorted and the already sorted item can be determined through comparing of full information. As a result, less memory space is required by the sorting method of the present invention.

Please note that although the insertion-sorting algorithm is used in the above-mentioned example, other kinds of sorting algorithm can also be used with the present invention. The definition of partial information and full information of each item can be decided by system designers. For example, with more information included in partial information of each item, the easier the order can be determined in step 220 and the lower the chance that the processor 110 goes to step 240 to compare full information. However, with more information included in partial information of each item, more memory space of the memory 130 is consumed. In addition, in step 240, the processor 110 retrieves only full information of already sorted item(s) that have the same partial information as the item to be sorted, according to the addresses stored in the address list. Then the processor 110 compares full information of the already sorted item(s), which have the same partial as the item to be sorted, with full information of the item to be sorted to determine the order of these items.

In addition, the method of the present invention can be recorded as a program code stored in any kind of physical storage media, such as floppy discs, optical discs, hard discs, or other kinds of machine-readable storage media. When the program code for implementing the method of the present invention is executed by a machine, such as a computer, the machine become an apparatus implementing the method of the present invention. Additionally, the method of the present invention can also be represented by a program code and transmitted through any kind of communication channel, such as electrical wires, cables, optical fibers, or even wireless communication channels. When the program code for implementing the method of the present invention is received, loaded, and executed by a machine, such as a computer, the machine become an apparatus implementing the method of the present invention. While the program code is combined with a processor, the processor becomes a unique apparatus implementing the method of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sorting method for sorting a plurality of items stored in a storage device by utilizing a memory, the method comprising:
(a) retrieving full information of an item to be sorted from the storage device;
(b) comparing only partial information of the item to be sorted with partial information of at least one already sorted item stored in the memory to determine an order of the item to be sorted and the already sorted items; and
(c) storing partial information of the already sorted items and partial information of the item to be sorted into the memory according to the determined order.

2. The method of claim 1 further comprising:
(d) if the order of the item to be sorted and the already sorted items cannot be determined in step (b), retrieving full information of at least one item having the same partial information as the item to be sorted among the already sorted items from the storage device, comparing full information of the item to be sorted with full information of the already sorted items having the same partial information as the item to be sorted to determine the order of the item to be sorted and the already sorted items.

3. The method of claim 2 further comprising:
(e) storing addresses of the already sorted items in the storage device and an address of the item to be sorted in the storage device into the memory according to the determined order.

4. The method of claim 3, wherein step (d) further comprises:
retrieving full information of the items having the same partial information as the item to be sorted from the storage device according the addresses stored in the memory.

5. An apparatus for sorting a plurality of items, the apparatus comprising:
a storage device for storing the plurality of items;
a memory; and
a processor electrically connected to the storage device and the memory, for sorting the plurality of items stored in the storage device by utilizing the memory;
wherein for an item to be sorted stored in the storage device, the processor retrieves full information of the item to be sorted from the storage device, compares only partial information of the item to be sorted with partial information of at least one already sorted item stored in the memory to determine an order of the item to be sorted and the already sorted items.

6. The apparatus of claim 5, wherein the memory stores addresses of the already sorted items in the storage device and an address of the item to be sorted in the storage device according to the order determined by the processor.

7. The apparatus of claim 6, wherein if the order cannot be determined by the processor by comparing the partial information of the item to be sorted with partial information of the already sorted items stored in the memory, the processor further retrieves full information of at least one item having the same partial information as the item to be sorted among the already sorted items from the storage device, compares full information of the item to be sorted with full information of the items having the same partial information as the item to be sorted to determine the order of the item to be sorted and the already sorted items.

8. The apparatus of claim 7, wherein the processor retrieves full information of the items having the same partial information as the item to be sorted from the storage device according the addresses stored in the memory.

9. The apparatus of claim 5, wherein the apparatus is set in a cellular phone.

10. A machine-readable medium storing a computer program which when executed by a processor enables the processor to perform a method to sort a plurality of items stored in a storage device by utilizing a memory, the method comprising:
(a) retrieving full information of an item to be sorted from the storage device;
(b) comparing only partial information of the item to be sorted with partial information of at least one already sorted item stored in the memory to determine an order of the item to be sorted and the already sorted items; and
(c) storing partial information of the already sorted items and partial information of the item to be sorted into the memory according to the determined order.
